(19) United States
(12) Patent Application Publication
(10) Pub. No.: US 2026/0034452 A1
(43) Pub. Date: Feb. 5, 2026

(54) GAME INTERACTION METHOD AND APPARATUS, DEVICE, AND COMPUTER-READABLE STORAGE MEDIUM

(71) Applicant: Tencent Technology (Shenzhen) Company Limited, Shenzhen (CN)

(72) Inventor: Yizhou LI, Shenzhen (CN)

(21) Appl. No.: 19/354,693

(22) Filed: Oct. 9, 2025

Related U.S. Application Data
(63) Continuation of application No. PCT/CN2024/010554, filed on Jul. 15, 2024.

(30) Foreign Application Priority Data
Sep. 26, 2023 (CN) 202311257021.7

(51) Int. Cl. A63F 13/56; A63F 13/573; A63F 13/58; A63F 13/837

(52) U.S. Cl. CPC A63F 13/56; A63F 13/573; A63F 13/58; A63F 13/837

(57) ABSTRACT

A game interaction method is performed by a computer device. The method includes: displaying a virtual scene including a virtual object holding a virtual projectile and a throwing control, and the throwing control being configured for throwing the virtual projectile; in response to a trigger operation for the throwing control, generating a throwing curve of the virtual projectile in the virtual scene, at least one attribute of the throwing curve being determined based on a remaining physical strength value of the virtual object, and the at least one attribute comprising at least one of a transparency, a throwing deflection angle, a throwing height, or a throwing distance; and in response to that the trigger operation ends, throwing the virtual projectile according to the throwing curve. Accordingly, the diversity of game interaction and the display effect of a throwing curve are improved, and the human-computer interaction rate is increased.

### CROSS-REFERENCE TO RELATED APPLICATIONS

This application is a continuation application of PCT Patent Application No. PCT/CN2024/105554, entitled “GAME INTERACTION METHOD AND APPARATUS, DEVICE, AND COMPUTER-READABLE STORAGE MEDIUM” filed on Jul. 15, 2024, which claims priority to Chinese Patent Application No. 202311257021.7, entitled “GAME INTERACTION METHOD AND APPARATUS, DEVICE, AND COMPUTER-READABLE STORAGE MEDIUM” and filed on Sep. 26, 2023, all of which are incorporated herein by reference in their entirety.

### FIELD OF THE TECHNOLOGY

Embodiments of this application relate to the field of computer technologies, and in particular, to a game interaction method and apparatus, a device, and a computer-readable storage medium.

### BACKGROUND OF THE DISCLOSURE

With continuous development of computer technologies, electronic games have become a common entertainment manner in daily life of people. Diversity and display effects of game interaction become important factors for attracting players. Therefore, a game interaction method needs to be provided, to improve the diversity and the display effects of game interaction.

### SUMMARY

Embodiments of this application provide a game interaction method and apparatus, a device, and a computer-readable storage medium, which can improve the diversity of game interaction and the display effects, to further increase the human-computer interaction rate. The technical solutions are as follows:

According to an aspect, an embodiment of this application provides a game interaction method, performed by a computer device, the method including:
displaying a virtual scene including a virtual object holding a virtual projectile and a throwing control, and the throwing control being configured for throwing the virtual projectile;
in response to a trigger operation for the throwing control, generating a throwing curve of the virtual projectile in the virtual scene, at least one attribute of the throwing curve being determined based on a remaining physical strength value of the virtual object, and the at least one attribute comprising at least one of a transparency, a throwing deflection angle, a throwing height, or a throwing distance; and
in response to that the trigger operation ends, throwing the virtual projectile according to the throwing curve.

According to another aspect, an embodiment of this application provides a computer device, including a processor and a memory, the memory having at least one program code stored therein, and the at least one program code, when being loaded and executed by the processor, causing the computer device to implement any one of the foregoing game interaction methods.

According to another aspect, a non-transitory computer-readable storage medium is further provided, the non-transitory computer-readable storage medium including at least one program code, and the at least one program code, when being loaded and executed by a processor of a computer device, causing the computer device to implement any one of the foregoing game interaction methods.

In the technical solutions provided in the embodiments of this application, when a virtual projectile is thrown, an attribute of a throwing curve of the virtual projectile is determined according to a remaining physical strength value of a virtual object, and then the virtual projectile is displayed according to the attribute of the throwing curve of the virtual projectile. The attribute of the throwing curve of the virtual projectile is associated with the remaining physical strength value of the virtual object, so that the throwing curve of the virtual projectile is more diversified and has a better display effect, thereby facilitating in improvement of the interaction experience of players and increasing the human-computer interaction rate. In addition, the display manner of the throwing curve enables a player to know a situation in which the virtual projectile is thrown under the current remaining physical strength value, so that the player can appropriately control, according to the current remaining physical strength value, a frequency of throwing the virtual projectile, thereby enabling the utilization of the virtual projectile to be more appropriate.

### BRIEF DESCRIPTION OF THE DRAWINGS

FIG. 1 is a schematic diagram of an implementation environment of a game interaction method according to an embodiment of this application.

FIG. 2 is a flowchart of a game interaction method according to an embodiment of this application.

FIG. 3 is a schematic display diagram of a virtual scene according to an embodiment of this application.

FIG. 4 is a schematic diagram of an image of a first function according to an embodiment of this application.

FIG. 5 is a schematic display diagram of a throwing curve of a virtual projectile according to an embodiment of this application.

FIG. 6 is a schematic diagram of an image of a third function according to an embodiment of this application.

FIG. 7 is a schematic diagram of a process of determining a throwing direction and a throwing deflection angle of a virtual projectile according to an embodiment of this application.

FIG. 8 is a schematic diagram of an image of a second function according to an embodiment of this application.

FIG. 9 is a schematic display diagram of a throwing curve of another virtual projectile according to an embodiment of this application.

FIG. 10 is a flowchart of a game interaction method according to an embodiment of this application.

FIG. 11 is a schematic structural diagram of a game interaction apparatus according to an embodiment of this application.

FIG. 12 is a schematic structural diagram of a terminal device according to an embodiment of this application.

FIG. 13 is a schematic structural diagram of a server according to an embodiment of this application.

### DESCRIPTION OF EMBODIMENTS

To make the objectives, technical solutions, and advantages of this application clearer, the following further describes implementations of this application in detail with reference to the accompanying drawings.

The terms “first”, “second”, and so on in this application are intended to distinguish similar objects but do not necessarily indicate a specific order or sequence. Such used data is interchangeable where appropriate so that the embodiments of this application described here can be implemented in an order other than those illustrated or described here. The implementations described in the following exemplary embodiments do not represent all implementations consistent with this application. On the contrary, the implementations are merely examples of an apparatus and a method that are consistent with some aspects of this application described in detail in claims.

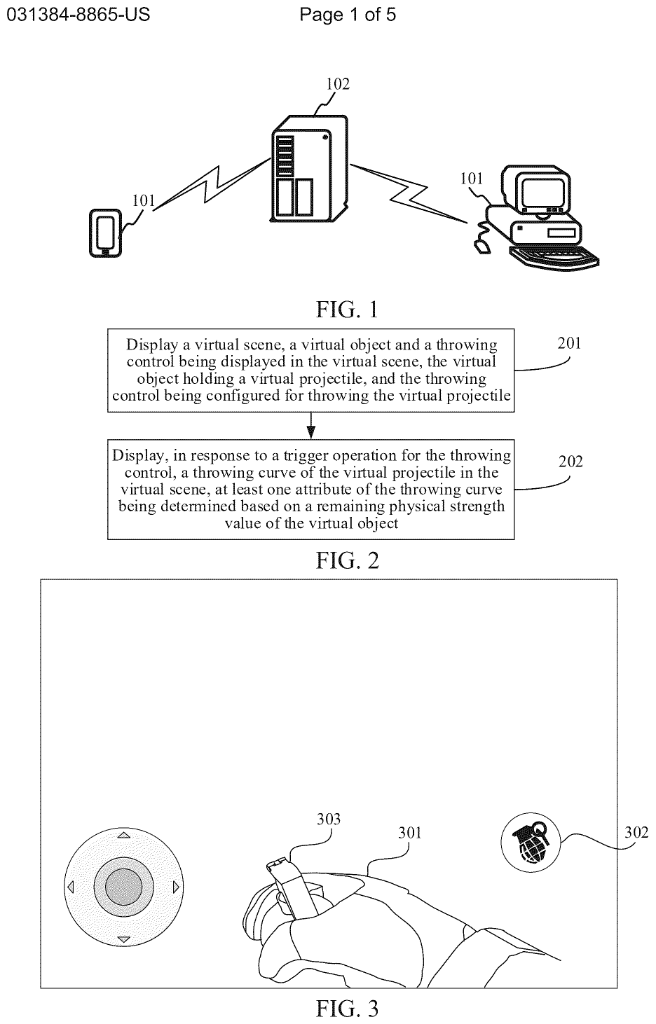

FIG. 1 is a schematic diagram of an implementation environment of a game interaction method according to an embodiment of this application. As shown in FIG. 1, the implementation environment includes a terminal device 101 and a server 102.

A client that can provide a virtual scene is installed and run in the terminal device 101. The terminal device 101 can be configured to perform the game interaction method according to this embodiment of this application.

The virtual scene is a scene created for a virtual object to perform activities. The virtual scene may be any one of a two-dimensional virtual scene, a 2.5-dimensional virtual scene, or a three-dimensional virtual scene. The virtual scene may be a simulated scene of the real world, or may be a semi-simulated and semi-fictional scene, or may be a purely fictional scene.

The virtual object refers to a movable object in the virtual scene. The virtual object may be a virtual character, a virtual animal, an animation character, or the like, such as a person, an animal, a plant, an oil drum, a wall, or a stone displayed in the virtual scene. A player may manipulate the virtual object by using a peripheral component or by tapping and touching a display screen. Each virtual object has a shape and a volume in the virtual scene, and occupies some space in the virtual scene. Exemplarily, when the virtual scene is a 3D virtual scene, the virtual object is a 3D model created based on a skeletal animation technology.

A type of the client that can provide the virtual scene is not limited in this embodiment of this application. For example, the client that can provide a virtual scene is a game client, for example, a third-person shooting (TPS) game, a first-person shooting (FPS) game, a multiplayer online battle arena (MOBA) game, a multiplayer shooting survival game, a massive multiplayer online role-playing game (MMO), or an action role playing game (ARPG).

Certainly, in addition to the game client, the game client that can provide the virtual scene may alternatively be a client of another type, for example, a virtual reality (VR) client, an augmented reality (AR) client, a three-dimensional map program, a map simulation program, a social application program, or an interactive entertainment application program.

The server 102 is configured to provide a back-end service for the client that can provide the virtual scene and is installed in the terminal device 101. In a possible implementation, the server 102 takes on primary computing work, and the terminal device 101 takes on secondary computing work. Alternatively, the server 102 takes on the secondary computing work, and the terminal device 101 takes on the primary computing work. Alternatively, collaborative computing is performed between the server 102 and the terminal device 101 by using a distributed computing architecture.

In some embodiments, the terminal device 101 may be any electronic product that can perform human-computer interaction with a user in one or more manners such as a keyboard, a touchpad, a remote control, voice interaction, or a handwriting device, for example, a personal computer (PC), a mobile phone, a smartphone, a personal digital assistant (PDA), a wearable device, a pocket PC (PPC), a tablet computer, a smart on board unit, a smart television, or a smart speaker.

The server 102 may be one server, a server cluster formed by multiple servers, or any one of a cloud computing platform or a virtualization center. This is not limited in this embodiment of this application. The server 102 may perform communication connection with the terminal device 101 through a wired network or a wireless network. The server 102 has a data receiving function, a data processing function, and a data transmitting function. Certainly, the server 102 may further have other functions. This is not limited in this embodiment of this application. In some embodiments, the server 102 can further be configured to perform the game interaction method provided in this embodiment of this application.

A person skilled in the art can understand that the terminal device 101 and the server 102 are only examples, and other existing or future possible terminal devices or servers that are applicable to this application are also to be included in the scope of protection of this application, and are included herein by reference.

An embodiment of this application provides a game interaction method, applicable to the foregoing implementation environment shown in FIG. 1. For example, in a flowchart of a game interaction method according to an embodiment of this application shown in FIG. 2, the method may be performed by a computer device. The computer device may be a terminal device 101 in FIG. 1, or may be a server 102 in FIG. 1. For example, the method may be performed by the terminal device 101 in FIG. 1, or may be implemented by interaction between the terminal device 101 and the server 102. This embodiment of this application is described by using an example in which the terminal device 101 is an execution body. As shown in FIG. 2, the method includes the following operation 201 to operation 202.

Operation 201: Display a virtual scene, a virtual object and a throwing control being displayed in the virtual scene, the virtual object holding a virtual projectile, and the throwing control being configured for throwing the virtual projectile.

In an exemplary embodiment of this application, a client that can provide a virtual scene is installed and run in a terminal device. The client may be a client of any type. This is not limited in this embodiment of this application. For example, the client is a game client. The game client as referred to in this embodiment of this application is a game client based on frame synchronization. That is, the game interaction method according to this embodiment of this application is applicable to the game client based on frame synchronization.

Related information of the client is displayed on a display interface of the terminal device. The related information of the client may be an icon of the client, a name of the client, or other information that can uniquely represent the client. This is not limited in this embodiment of this application. When a target object wants to run the client, the target object selects the related information of the client, the terminal device receives a selected instruction for the related information of the client, and displays a home page of the client. A start control is displayed on the home page of the client, and the start control is configured for starting a round of game. The target object selects the start control, the terminal device receives the selected instruction for the start control, and displays a virtual scene, a virtual object and a throwing control being displayed in the virtual scene, the virtual object holding a virtual projectile, and the throwing control being configured for throwing the virtual projectile. The virtual object is an object controlled by the target object, and the target object is an object using the terminal device, that is, an object that logs into the client. In some embodiments, the target object can also be referred to as a player, a user, or the like. In some embodiments, the virtual object holding a virtual projectile may refer to the virtual object holding a virtual projectile in hands.

For example, the target object selecting the related information of the client may refer to the target object clicking/tapping on the related information of the client, or may refer to the target object double-clicking/tapping on the related information of the client, or may refer to the target object selecting the related information of the client in a voice manner, or may refer to selecting the related information of the client in another manner. This is not limited in this embodiment of this application. A manner in which the target object selects the start control is similar to the manner in which the target object selects the related information of the client. Details are not described herein again.

The virtual projectile may be any prop that can be thrown in a virtual scene. For example, the virtual projectile may be a virtual fragment grenade, a virtual attack grenade, a virtual frangible grenade, a virtual tear gas grenade, a virtual smoke grenade, a virtual flash grenade, a virtual stun grenade, a virtual footstep generator, or a virtual hand grenade.

For example, the virtual projectile held by the virtual object may be a projectile configured by the target object for the virtual object, or may be a projectile owned by the virtual object by default, or may be a projectile picked up by the virtual object in a virtual scene, or the like. This is not limited in this embodiment of this application.

The form of the throwing control may be a triggerable icon, a triggerable button, or the like. This is not limited in this embodiment of this application. The display location of the throwing control in the virtual scene may be set based on experience, or may be flexibly adjusted according to an implementation environment. This is not limited in this embodiment of this application. For example, the throwing control may be displayed in a lower right area in the virtual scene, or may be displayed in an upper right area in the virtual scene, or the like.

FIG. 3 is a schematic display diagram of a virtual scene according to an embodiment of this application. A virtual object 301 and a throwing control 302 are displayed in FIG. 3. The virtual object 301 holds a virtual projectile 303 in one hand. In some embodiments, the virtual scene may further display another control. This is not limited in this embodiment of this application.

Step 202: Display, in response to a trigger operation for the throwing control, a throwing curve of the virtual projectile in the virtual scene, at least one attribute of the throwing curve being determined based on a remaining physical strength value of the virtual object.

The at least one attribute includes at least one of a transparency, a throwing deflection angle, a throwing height, and a throwing distance.

In a possible implementation, when the target object wants to throw the virtual projectile, the target object triggers the throwing control, the terminal device receives a trigger operation for the throwing control, and displays the throwing curve of the virtual projectile in the virtual scene. The trigger operation for the throwing control may be a press-and-hold operation on the throwing control, a one click/tap operation on the throwing control, a double click/tap operation on the throwing control, or the like. This is not limited in this embodiment of this application.

When the trigger operation for the throwing control is a press-and-hold operation for the throwing control, that the target object presses and holds the throwing control means that a duration for which the target object selects the throwing control is greater than a duration threshold. The duration threshold is set based on experience, or adjusted according to an implementation environment. This is not limited in this embodiment of this application. For example, the duration threshold is 3 seconds.

Before displaying the throwing curve of the virtual projectile in the virtual scene, at least one attribute of the throwing curve of the virtual projectile needs to be first determined. In a possible implementation, a process of determining at least one attribute of the throwing curve includes: determining a remaining physical strength value of the virtual object in response to a trigger operation for the throwing control; determining a target physical strength value ratio, the target physical strength value ratio being a ratio of the remaining physical strength value of the virtual object to an original physical strength value of the virtual object; and determining the at least one attribute of the throwing curve according to the target physical strength value ratio.

The target physical strength value ratio is a value obtained after standardized processing is performed on the remaining physical strength value by using the original physical strength value. By determining the at least one attribute of the throwing curve according to the target physical strength value ratio, the standardization of the at least one attribute of the throwing curve can be improved, thereby improving the display effect of the throwing curve, improving the interaction experience of the target object, and further improving the human-computer interaction rate.

The original physical strength value of the virtual object refers to a physical strength value of the virtual object when the virtual object does not perform any activity that consumes the physical strength value, and the remaining physical strength value of the virtual object refers to a physical strength value of the virtual object after the virtual object performs some activities that consume the physical strength value based on the original physical strength value. For example, the original physical strength value of the virtual object may be a default value, for example, the original physical strength value may be 100.

An upper limb strength of the virtual object needs to be consumed for throwing the virtual projectile, and therefore the remaining physical strength value of the virtual object includes a remaining upper limb physical strength value of the virtual object, and the original physical strength value of the virtual object includes a maximum upper limb physical strength value of the virtual object. By determining the attribute of the throwing curve according to a ratio of the remaining upper limb physical strength value to the maximum upper limb physical strength value, the matching degree between the attribute of the throwing curve and the upper limb physical strength value of the virtual object can be improved. Throwing the virtual projectile consumes the upper limb strength, and therefore the reliability of the attribute of the throwing curve can be further improved by improving the matching degree between the attribute of the throwing curve and the upper limb physical strength value of the virtual object, thereby further improving the display effect of the throwing curve, and further improving the interaction experience of the target object and the human-computer interaction rate.

The descriptions of the remaining physical strength value and the original physical strength value are merely exemplary examples. These are not limited in this embodiment of this application. In some embodiments, the remaining physical strength value of the virtual object includes a remaining upper limb physical strength value of the virtual object, and the original physical strength value of the virtual object includes an overall maximum physical strength value of the virtual object. In some other embodiments, the remaining physical strength value of the virtual object includes an overall remaining physical strength value of the virtual object, and the original physical strength value of the virtual object includes an overall maximum physical strength value of the virtual object.

The mode of determining the remaining physical strength value of the virtual object is not limited in this embodiment of this application. In some embodiments, a process of determining the remaining physical strength value of the virtual object includes: generating a remaining physical strength value obtaining request, the remaining physical strength value obtaining request including an object identifier of the virtual object; and transmitting, by the terminal device, the remaining physical strength value obtaining request to a server. The server receives the remaining physical strength value obtaining request and parses the remaining physical strength value obtaining request, to obtain the object identifier of the virtual object. The server stores a correspondence between an object identifier of each object and a remaining physical strength value of each object. The server determines the remaining physical strength value of the virtual object according to the object identifier of the virtual object and the correspondence between the object identifier of each object and the remaining physical strength value of each object. The server transmits the remaining physical strength value of the virtual object to the terminal device, so that the terminal device obtains the remaining physical strength value of the virtual object.

Before the terminal device determines the target physical strength value ratio between the remaining physical strength value of the virtual object and the original physical strength value of the virtual object, the terminal device further needs to obtain the original physical strength value of the virtual object. A process in which the terminal device obtains the original physical strength value of the virtual object is similar to the foregoing process in which the terminal device obtains the remaining physical strength value of the virtual object. Details are not described herein again.

In some embodiments, a process of determining the remaining physical strength value of the virtual object may further include: calculating, by the terminal device, a remaining physical strength value of the virtual object in real time according to a pre-stored original physical strength value of the virtual object and a physical strength value consumed by an activity performed by the virtual object. The terminal device may store correspondences between activities and physical strength values. The terminal device can search the correspondences for a corresponding physical strength value according to the activity performed by the virtual object, and the corresponding physical strength value is a physical strength value consumed by the activity performed by the virtual object. In some embodiments, when the terminal device has the original physical strength value of the virtual object stored therein in advance, the terminal device may directly extract the stored original physical strength value of the virtual object.

After the terminal device obtains the remaining physical strength value of the virtual object and the original physical strength value of the virtual object, a process of determining the target physical strength value ratio of the remaining physical strength value of the virtual object to the original physical strength value of the virtual object includes: using a quotient of the remaining physical strength value of the virtual object and the original physical strength value of the virtual object as the target physical strength value ratio. For example, when the remaining physical strength value of the virtual object is a remaining upper limb physical strength value of the virtual object, the original physical strength value of the virtual object is a maximum upper limb physical strength value of the virtual object, the obtained remaining upper limb physical strength value of the virtual object is 30, and the maximum upper limb physical strength value of the virtual object is 100, the physical strength value ratio is 30/100=0.3.

The mode of determining at least one attribute of the throwing curve according to the target physical strength value ratio is related to the specific situation of the at least one attribute of the throwing curve. An implementation of determining at least one attribute of the throwing curve according to the target physical strength value ratio is described below with reference to the specific situation of the at least one attribute of the throwing curve.

In a possible implementation, the at least one attribute includes a transparency, and an implementation of determining at least one attribute of the throwing curve according to the target physical strength value ratio includes: determining a transparency of the first curve segment of the throwing curve according to the target physical strength value ratio. The transparency of the first curve segment is different from a transparency of a second curve segment, a ratio of a distance between any point included in the first curve segment and the virtual object to a length of the throwing curve is greater than a distance ratio, and the second curve segment is a curve segment other than the first curve segment in the throwing curve.

In other words, when the at least one attribute includes a transparency, before the throwing curve of the virtual projectile is displayed in the virtual scene, the transparency of the throwing curve needs to be first determined, and a process of determining the transparency of the throwing curve includes: determining a remaining physical strength value of the virtual object in response to a trigger operation for the throwing control; determining a target physical strength value ratio of the remaining physical strength value of the virtual object to an original physical strength value of the virtual object; determining a first transparency according to the target physical strength value ratio, a transparency of a first curve segment of the throwing curve displayed in the virtual scene being the first transparency, a transparency of a second curve segment being a second transparency, and the second transparency being different from the first transparency. In some embodiments, the first transparency may be higher than the second transparency, or the first transparency may be lower than the second transparency. The trigger operation for the throwing control may be a press-and-hold operation for the throwing control, or may be another operation. This is not limited in this embodiment of this application.

When the at least one attribute includes the transparency, a transparency of a curve segment away from the curve segment (the first curve segment) of the virtual object in the throwing curve is determined according to the target physical strength value ratio, so that the correlation between the transparency of the curve segment away from the curve segment of the virtual object in the throwing curve and the target physical strength value ratio can be improved, thereby improving the display effect of the throwing curve in terms of transparency, further improving the interaction experience of the target object, and improving the human-computer interaction rate.

In a possible implementation, a process of determining a transparency of the first curve segment (that is, the first transparency) according to the target physical strength value ratio includes: obtaining a correspondence between the transparency and the physical strength value ratio; and determining the transparency of the first curve segment (that is, the first transparency) according to the target physical strength value ratio and the correspondence between the transparency and the physical strength value ratio.

By searching the correspondence between the transparency and the physical strength value ratio, the transparency of the first curve segment can be conveniently determined, thereby improving the efficiency of determining the transparency of the first curve segment, improving the efficiency of determining the at least one attribute of the throwing curve, and further improving the display efficiency of the throwing curve.

In an exemplary embodiment, a process of obtaining a correspondence between the transparency and the physical strength value ratio includes: obtaining a first physical strength value ratio, a transparency corresponding to the first physical strength value ratio, a second physical strength value ratio, and a transparency corresponding to the second physical strength value ratio; constructing a first reference function, the first reference function being a unary once function; and adjusting the first reference function according to the first physical strength value ratio, the transparency corresponding to the first physical strength value ratio, the second physical strength value ratio, and the transparency corresponding to the second physical strength value ratio, to obtain a first function, the first function being configured for indicating the correspondence between the transparency and the physical strength value ratio.

The correspondence between the transparency and the physical strength value ratio is obtained by adjusting the first reference function according to the two groups of physical strength value ratio-transparency data. The calculation logic is relatively simple, facilitating in improving the efficiency of obtaining the correspondence between the transparency and the physical strength value ratio, thereby improving the efficiency of determining the transparency of the first curve segment, improving the efficiency of determining the at least one attribute of the throwing curve, and improving the display efficiency of the throwing curve.

For example, a process of adjusting the first reference function according to the first physical strength value ratio, the transparency corresponding to the first physical strength value ratio, the second physical strength value ratio, and the transparency corresponding to the second physical strength value ratio, to obtain a first function includes: respectively substituting the first physical strength value ratio and the transparency corresponding to the first physical strength value ratio into an independent variable and a dependent variable of the first reference function, to obtain a first calculation formula; respectively substituting the second physical strength value ratio and the transparency corresponding to the second physical strength value ratio into the independent variable and the dependent variable of the first reference function, to obtain a second calculation formula; solving a slope and an intercept of the first reference function according to the first calculation formula and the second calculation formula; and substituting the slope and the intercept obtained through solving into the first reference function, to obtain the first function.

For example, the first physical strength value ratio is 0, the transparency corresponding to the first physical strength value ratio is 1, the second physical strength value ratio is 0.5, the transparency corresponding to the second physical strength value ratio is 0, and the constructed first reference function is y=k₁x+b₁, where x is an independent variable of the first reference function, y is a dependent variable of the first reference function, k₁ is a slope of the first reference function, and b₁ is an intercept of the first reference function. (0, 1) and (0.5, 0) are respectively substituted into the first reference function, to obtain K₁=−2 and b₁=1. k₁=−2 and b₁=1 are substituted into the first reference function, to obtain the first function y=−2x+1. FIG. 4 is a schematic diagram of an image of a first function according to an embodiment of this application.

In some embodiments, a process of determining a first transparency according to the target physical strength value ratio and the correspondence between the transparency and the physical strength value ratio includes: substituting the target physical strength value ratio into the first function, to obtain the first transparency. For example, the target physical strength value ratio is 0.3, and 0.3 is substituted into the first function y=−2x+1, to obtain the first transparency, 0.4.

In an exemplary embodiment, the transparency of the second curve segment (that is, the second transparency) may be a default transparency, or may be a transparency determined according to the transparency of the first curve segment (that is, the first transparency), provided that the second transparency is different from the first transparency.

For example, the second transparency is determined according to the first transparency. After the first transparency is determined, a process of determining a second transparency according to the first transparency includes: using a transparency lower than the first transparency as the second transparency, for example, 0 being used as the second transparency; or, using a transparency higher than the first transparency as the second transparency, for example, 0.5 being used as the second transparency.

After the first transparency and the second transparency are determined, the throwing curve of the virtual projectile is generated according to the first transparency and the second transparency, and the throwing curve of the virtual projectile is displayed in the virtual scene, the transparency of the first curve segment of the throwing curve being the first transparency, and the transparency of the second curve segment being the second transparency. A ratio of a distance between any point included in the first curve segment and the virtual object to a length of the throwing curve is greater than a distance ratio, and the second curve segment is a curve segment other than the first curve segment in the throwing curve. The distance ratio is set based on experience, or adjusted according to an implementation environment. This is not limited in this embodiment of this application. For example, the distance ratio is 70%. That is, first 70% of curve segment close to the virtual object in the throwing curve is the second curve segment, and the remaining curve segment is the first curve segment.

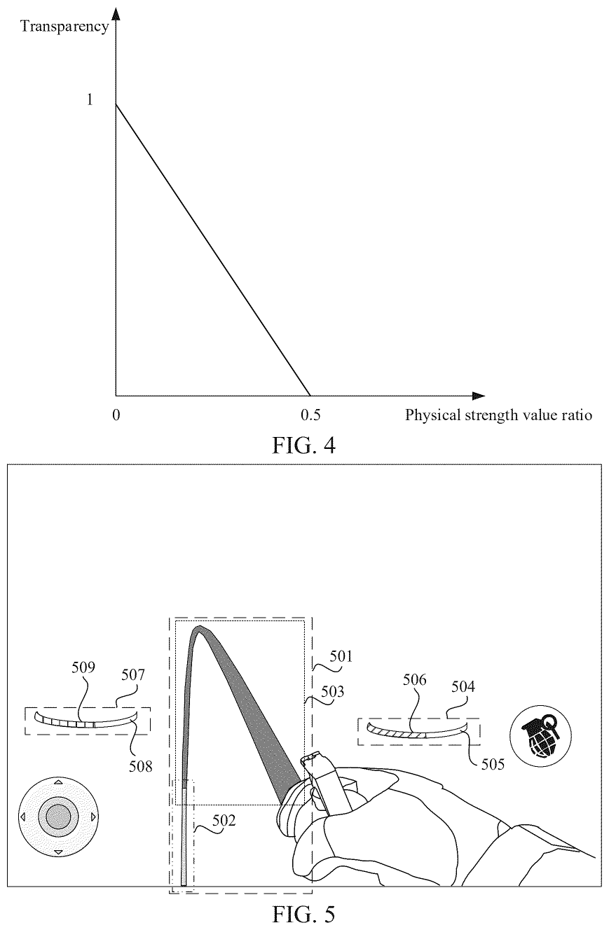

FIG. 5 is a schematic display diagram of a throwing curve of a virtual projectile according to an embodiment of this application. In FIG. 5, 501 is the throwing curve of the virtual projectile, 502 is the first curve segment, and 503 is the second curve segment. A transparency of the first curve segment 502 is the first transparency, and a transparency of the second curve segment 503 is the second transparency.

In some embodiments, an upper limb physical strength bar of the virtual object is further displayed in the virtual scene, the upper limb physical strength bar of the virtual object is configured for indicating the remaining upper limb physical strength value of the virtual object and the maximum upper limb physical strength value of the virtual object, and the remaining upper limb physical strength value of the virtual object and the maximum upper limb physical strength value of the virtual object are displayed in the upper limb physical strength bar of the virtual object in different manners.

By displaying the upper limb physical strength bar of the virtual object and displaying the remaining upper limb physical strength value and the maximum upper limb physical strength value of the virtual object in the upper limb physical strength bar in different display manners, the target object can intuitively distinguish the remaining upper limb physical strength value and the maximum upper limb physical strength value of the virtual object, thereby improving the visual effect of the target object, further improving the interaction experience of the target object, and improving the human-computer interaction rate.

For example, 504 in FIG. 5 is the upper limb physical strength bar of the virtual object, 505 is configured for indicating the maximum upper limb physical strength value of the virtual object, and 506 is configured for indicating the remaining upper limb physical strength value of the virtual object.

In some embodiments, a lower limb physical strength bar of the virtual object is further displayed in the virtual scene, the lower limb physical strength bar of the virtual object is configured for indicating the remaining lower limb physical strength value of the virtual object and the maximum lower limb physical strength value of the virtual object, and the remaining lower limb physical strength value of the virtual object and the maximum lower limb physical strength value of the virtual object are displayed in the lower limb physical strength bar of the virtual object in different manners.

By displaying the lower limb physical strength bar of the virtual object and displaying the remaining lower limb physical strength value and the maximum lower limb physical strength value of the virtual object in the lower limb physical strength bar in different display manners, the target object can intuitively distinguish the remaining lower limb physical strength value and the maximum lower limb physical strength value of the virtual object, thereby improving the visual effect of the target object, further improving the interaction experience of the target object, and improving the human-computer interaction rate.

For example, 507 in FIG. 5 is the lower limb physical strength bar of the virtual object, 508 is configured for indicating the maximum lower limb physical strength value of the virtual object, and 509 is configured for indicating the remaining lower limb physical strength value of the virtual object.

In a possible implementation, the at least one attribute includes the throwing deflection angle, and a process of determining at least one attribute of the throwing curve according to the target physical strength value ratio includes: determining the throwing deflection angle of the throwing curve according to the target physical strength value ratio, the throwing deflection angle being configured for indicating a deflection angle of a throwing direction when the virtual object throws the virtual projectile at the target physical strength value ratio.

In other words, when the at least one attribute includes the throwing deflection angle, before the throwing curve of the virtual projectile is displayed in the virtual scene, the throwing deflection angle of the throwing curve needs to be first determined, and a process of determining the throwing deflection angle includes: determining a remaining physical strength value of the virtual object in response to a trigger operation for the throwing control, and determining a target physical strength value ratio between the remaining physical strength value of the virtual object and a target physical strength value of the virtual object; determining a target angle according to the target physical strength value ratio, the target angle being configured for indicating a deflection angle of a throwing direction when the virtual object throws the virtual projectile at the target physical strength value ratio; and a throwing deflection angle of the throwing curve of the virtual projectile displayed in the virtual scene being the target angle.

When the at least one attribute includes the throwing deflection angle, the throwing deflection angle of the throwing curve is determined according to the target physical strength value ratio, so that the correlation between the throwing deflection angle of the throwing curve and the target physical strength value ratio can be improved, thereby improving the display effect of the throwing curve in terms of throwing deflection angle, further improving the interaction experience of the target object, and improving the human-computer interaction rate.

As the remaining physical strength value of the virtual object decreases, the accuracy of throwing the virtual projectile may decrease, that is, deflection may occur during throwing of the virtual projectile. For example, the throwing deflection angle is in a negative correlation with the remaining physical strength value of the virtual object. That is, a smaller remaining physical strength value of the virtual object indicates a larger throwing deflection angle, so that a larger deflection occurs during throwing of the virtual projectile.

A manner of determining the throwing deflection angle (that is, the target angle) of the throwing curve according to the target physical strength value ratio is not limited in this embodiment of this application. In some embodiments, a process of determining a throwing deflection angle (that is, the target angle) of the throwing curve according to the target physical strength value ratio includes: obtaining a correspondence between the deflection angle and the physical strength value ratio; and determining the throwing deflection angle (that is, the target angle) of the throwing curve according to the target physical strength value ratio and the correspondence between the deflection angle and the physical strength value ratio.

By searching the correspondence between the deflection angle and the physical strength value ratio, the throwing deflection angle of the throwing curve can be conveniently determined, thereby improving the efficiency of determining the throwing deflection angle of the throwing curve, improving the efficiency of determining the at least one attribute of the throwing curve, and further improving the display efficiency of the throwing curve.

For example, a process of obtaining a correspondence between the deflection angle and the physical strength value ratio includes: obtaining a first physical strength value ratio, a throwing deflection angle corresponding to the first physical strength value ratio, a second physical strength value ratio, and a throwing deflection angle corresponding to the second physical strength value ratio; constructing a third reference function, the third reference function being a unary once function; and adjusting the third reference function according to the first physical strength value ratio, the throwing deflection angle corresponding to the first physical strength value ratio, the second physical strength value ratio, and the throwing deflection angle corresponding to the second physical strength value ratio, to obtain a third function, the third function being configured for indicating the correspondence between the deflection angle and the physical strength value ratio.

The correspondence between the deflection angle and the physical strength value ratio is obtained by adjusting the third reference function according to the two groups of physical strength value ratio-throwing deflection angle data. The calculation logic is relatively simple, facilitating in improving the efficiency of obtaining the correspondence between the deflection angle and the physical strength value ratio, thereby improving the efficiency of determining the throwing deflection angle of the throwing curve, improving the efficiency of determining the at least one attribute of the throwing curve, and improving the display efficiency of the throwing curve.

For example, a process of adjusting the third reference function according to the first physical strength value ratio, the throwing deflection angle corresponding to the first physical strength value ratio, the second physical strength value ratio, and the throwing deflection angle corresponding to the second physical strength value ratio, to obtain a third function includes: respectively substituting the first physical strength value ratio and the throwing deflection angle corresponding to the first physical strength value ratio into an independent variable and a dependent variable of the third reference function, to obtain a third calculation formula; respectively substituting the second physical strength value ratio and the throwing deflection angle corresponding to the second physical strength value ratio into the independent variable and the dependent variable of the third reference function, to obtain a fourth calculation formula; solving slope and an intercept of the third reference function according to the third calculation formula and the fourth calculation formula; and substituting the slope and the intercept obtained through solving into the third reference function, to obtain the third function.

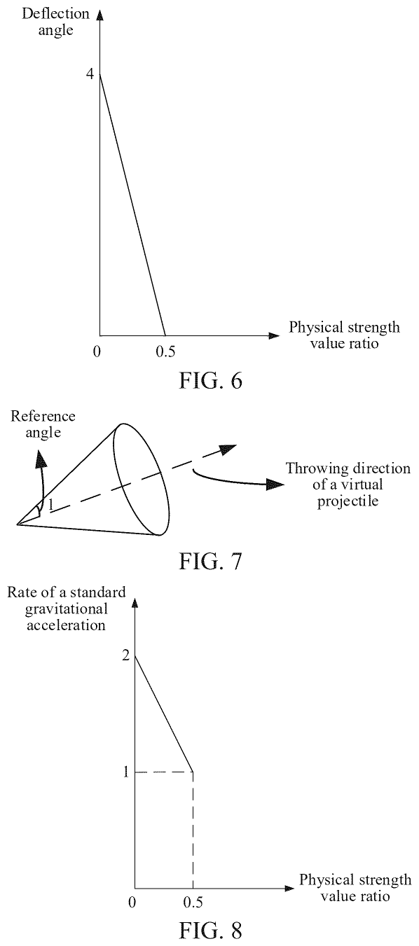

For example, the first physical strength value ratio is 0, the throwing deflection angle corresponding to the first physical strength value ratio is 4, the second physical strength value ratio is 0.5, the throwing deflection angle corresponding to the second physical strength value ratio is 0, and the constructed third reference function is y=k₃x+b₃, where x is an independent variable of the third reference function, and y is a dependent variable of the third reference function, K₃ is a slope of the third reference function, and b₃ is an intercept of the third reference function. (0, 4) and (0.5, 0) are respectively substituted into the third reference function, to obtain k₃=−8 and b₃=4. k₃=−8, b₃=4 are substituted into the third reference function, to obtain the third function y=−8x+4. FIG. 6 is a schematic diagram of an image of a third function according to an embodiment of this application.

In some embodiments, a process of determining a target angle according to the target physical strength value ratio and the correspondence between the deflection angle and the physical strength value ratio includes: substituting the target physical strength value ratio into the third function, to obtain the target angle. In some embodiments, the target physical strength value ratio is substituted into the third function, to obtain a reference angle. The reference angle is used as the target angle, or any angle less than the reference angle is used as the target angle. The value of the target angle is a positive integer. For example, the target physical strength value ratio is 0.3, and 0.3 is substituted into the third function y=−8x+4, to obtain the reference angle, 1.6. In some embodiments, 1.6 may be used as the target angle. Alternatively, an angle less than 1.6 may be used as the target angle. For example, 1 is used as the target angle.

FIG. 7 is a schematic diagram of a process of determining a throwing direction and a throwing deflection angle of a virtual projectile according to an embodiment of this application. In FIG. 7, the dashed line with an arrow is a direction vector of the throwing direction of the virtual projectile, and the angle 1 is the reference angle. A cone is obtained according to the reference angle and the throwing direction of the virtual projectile. From the vertex of a threshold inner cone, an angle between any direction vector in the cone and the direction vector of the throwing direction of the virtual projectile is the throwing deflection angle of the throwing direction of the virtual projectile.

In a possible implementation, the at least one attribute includes a throwing height, and a process of determining at least one attribute of the throwing curve according to the target physical strength value ratio includes: determining a gravitational acceleration corresponding to the virtual projectile according to the target physical strength value ratio; and determining the throwing height of the throwing curve according to the gravitational acceleration corresponding to the virtual projectile.

In other words, when the at least one attribute includes the throwing height, before the throwing curve of the virtual projectile is displayed in the virtual scene, the throwing height of the throwing curve needs to be first determined, and a process of determining the throwing height includes: determining a remaining physical strength value of the virtual object in response to a trigger operation for the throwing control; determining a target physical strength value ratio between the remaining physical strength value of the virtual object and a target physical strength value of the virtual object; determining a gravitational acceleration corresponding to the virtual projectile according to the target physical strength value ratio; determining a target height according to the gravitational acceleration corresponding to the virtual projectile; and the throwing height of the throwing curve of the virtual projectile displayed in the virtual scene being the target height.

When the at least one attribute includes the throwing height, the throwing height of the throwing curve is determined according to the target physical strength value ratio, so that the correlation between the throwing height of the throwing curve and the target physical strength value ratio can be improved, thereby improving the display effect of the throwing curve in terms of throwing height, further improving the interaction experience of the target object, and improving the human-computer interaction rate.

The throwing height refers to a distance between the highest throwing point of the virtual projectile and the ground, for example, a vertical distance between the highest throwing point of the virtual projectile and the ground. As the remaining physical strength value of the virtual object decreases, the throwing height of the virtual projectile may decrease accordingly. When the remaining physical strength value of the virtual object gradually restores, the throwing height of the virtual projectile may increase accordingly. For example, the throwing height is in a positive correlation with the remaining physical strength value of the virtual object. That is, a smaller remaining physical strength value of the virtual object indicates a larger throwing height.

A process of determining the remaining physical strength value of the virtual object and the target physical strength value ratio are as described above. Details are not described herein again. A process of determining a gravitational acceleration corresponding to the virtual projectile according to the target physical strength value ratio is not limited in this embodiment of this application. In some embodiments, a correspondence between a rate of a standard gravitational acceleration and a physical strength value ratio is obtained; a rate of the standard gravitational acceleration corresponding to the target physical strength value ratio is determined according to the target physical strength value ratio and the correspondence between the rate of the standard gravitational acceleration and the physical strength value ratio; and a gravitational acceleration corresponding to the virtual projectile is determined according to the rate of the standard gravitational acceleration corresponding to the target physical strength value ratio and the standard gravitational acceleration. The standard gravitational acceleration (g) is 9.8 m/s² (m/s²).

By searching the correspondence between the rate of the standard gravitational acceleration and the physical strength value ratio, the rate of the standard gravitational acceleration corresponding to the target physical strength value ratio can be conveniently determined, thereby improving the efficiency of determining the gravitational acceleration corresponding to the virtual projectile, improving the efficiency of determining the throwing height of the throwing curve, improving the efficiency of determining the at least one attribute of the throwing curve, and further improving the display efficiency of the throwing curve.

For example, a process of obtaining a correspondence between the rate of the standard gravitational acceleration and the physical strength value ratio includes: obtaining a first physical strength value ratio, a rate of a standard gravitational acceleration corresponding to the first physical strength value ratio, a second physical strength value ratio, and a rate of a standard gravitational acceleration corresponding to the second physical strength value ratio; constructing a second reference function, the second reference function being a unary once function; and adjusting the second reference function according to the first physical strength value ratio, the rate of the standard gravitational acceleration corresponding to the first physical strength value ratio, the second physical strength value ratio, and the rate of the standard gravitational acceleration corresponding to the second physical strength value ratio, to obtain a second function, the second function being configured for indicating a correspondence between the rate of the standard gravitational acceleration and the physical strength value ratio.

The correspondence between the rate of the standard gravitational acceleration and the physical strength value ratio is obtained by adjusting the second reference function according to the two groups of physical strength value ratio-rate of standard gravitational acceleration data. The calculation logic is relatively simple, facilitating in improving the efficiency of obtaining the correspondence between the rate of the standard gravitational acceleration and the physical strength value ratio, thereby improving the efficiency of determining the throwing height of the throwing curve, improving the efficiency of determining the at least one attribute of the throwing curve, and improving the display efficiency of the throwing curve.

For example, a process of adjusting the second reference function according to the first physical strength value ratio, the rate of the standard gravitational acceleration corresponding to the first physical strength value ratio, the second physical strength value ratio, and the rate of the standard gravitational acceleration corresponding to the second physical strength value ratio, to obtain a second function includes: respectively substituting the first physical strength value ratio and the multiplication rate of the standard gravitational acceleration corresponding to the first physical strength value ratio into an independent variable and a dependent variable of the second reference function, to obtain a fifth calculation formula; respectively substituting the second physical strength value ratio and the multiplier of the standard gravitational acceleration corresponding to the second physical strength value ratio into the independent variable and the dependent variable of the second reference function, to obtain a sixth calculation formula; solving a slope and an intercept of the second reference function according to the fifth calculation formula and the sixth calculation formula; and substituting the slope and the intercept obtained through solving into the second reference function, to obtain the second function.

For example, the first physical strength value ratio is 0, the rate of the standard gravitational acceleration corresponding to the first physical strength value ratio is 2, the second physical strength value ratio is 0.5, the rate of the standard gravitational acceleration corresponding to the second physical strength value ratio is 1, and the constructed second reference function is y=k₂x+b₂, where x is an independent variable of the second reference function, y is a dependent variable of the second reference function, k₂ is a slope of the second reference function, and b₂ is an intercept of the second reference function. (0, 2) and (0.5, 1) are respectively substituted into the second reference function, to obtain k₂=−2 and b₂₌₂. K₂=−2 and b₂=2 are substituted into the second reference function, to obtain the second function y=−2x+2. FIG. 8 is a schematic diagram of an image of a second function according to an embodiment of this application.

In some embodiments, a process of determining a rate of the standard gravitational acceleration corresponding to the target physical strength value ratio according to the target physical strength value ratio and the correspondence between the rate of the standard gravitational acceleration and the physical strength value ratio includes: substituting the target physical strength value ratio into the second function, to obtain the rate of the standard gravitational acceleration corresponding to the target physical strength value ratio. For example, the target physical strength value ratio is 0.3, 0.3 is substituted into the second function y=−2x+2, to obtain the rate of the standard gravitational acceleration corresponding to the target physical strength value ratio, 1.4.

After the rate of the standard gravitational acceleration corresponding to the target physical strength value ratio is obtained, a process of determining a gravitational acceleration corresponding to the virtual projectile according to the rate of the standard gravitational acceleration corresponding to the target physical strength value ratio and the standard gravitational acceleration includes: using a product of the rate of the standard gravitational acceleration corresponding to the target physical strength value ratio and the standard gravitational acceleration as the gravitational acceleration corresponding to the virtual projectile.

For example, when the rate of the standard gravitational acceleration corresponding to the target physical strength value ratio is 1.4, the gravitational acceleration corresponding to the virtual projectile is 1.4×9.8=13.72 m/s².

In a possible implementation, a process of determining a throwing height (that is, the target height) of the throwing curve according to the gravitational acceleration corresponding to the virtual projectile includes: determining a throwing time according to the gravitational acceleration corresponding to the virtual projectile and a vertical initial speed of the virtual projectile; and determining the throwing height (that is, the target height) of the throwing curve according to the gravitational acceleration corresponding to the virtual projectile and the throwing time.

The throwing height is determined according to the throwing time and the gravitational acceleration, where the throwing time is determined according to the vertical initial speed, so that it can be ensured that the throwing height is a throwing height matching an actual physical falling situation, thereby improving the reliability of the throwing height, improving the display effect of the throwing curve, further improving the interaction experience of the target object, and improving the human-computer interaction rate.

The vertical initial speed of the virtual projectile is a component of an initial speed of the virtual projectile in the vertical direction. For example, the vertical initial speed of the virtual projectile is configured based on experience, or adjusted according to an implementation environment. This is not limited in this embodiment of this application. For example, the vertical initial speed of the virtual projectile is 10 m/s.

For example, a manner of determining a throwing time according to the gravitational acceleration corresponding to the virtual projectile and the vertical initial speed of the virtual projectile is: calculating a first ratio of the vertical initial speed of the virtual projectile to the gravitational acceleration corresponding to the virtual projectile, and determining the throwing time based on the first ratio. For example, the throwing time is determined based on the following Formula (1) according to the gravitational acceleration corresponding to the virtual projectile and the vertical initial speed of the virtual projectile.

$$t = \frac{{v}_{1}}{G} \qquad Formula ( 1 )$$

In the foregoing Formula (1), t is a throwing time, G is a gravitational acceleration corresponding to the virtual projectile, and v₁ is a vertical initial speed of the virtual projectile.

For example, a manner of determining the throwing height (that is, the target height) of the throwing curve according to the gravitational acceleration corresponding to the virtual projectile and the throwing time is: calculating a quadratic value of the throwing time; multiplying the quadratic value of the throwing time by the gravitational acceleration corresponding to the virtual projectile, to obtain a first product; and determining the throwing height (that is, the target height) of the throwing curve based on the first product. For example, the target height is determined based on the following Formula (2) according to the gravitational acceleration corresponding to the virtual projectile and the throwing time.

$$h = \frac{1}{2} {Gt}^{2} \qquad Formula ( 2 )$$

In the foregoing Formula (2), h is a target height, G is a gravitational acceleration corresponding to the virtual projectile, and t is a throwing time.

In a possible implementation, the at least one attribute includes a throwing distance, and a process of determining at least one attribute of the throwing curve according to the target physical strength value ratio includes: determining a gravitational acceleration corresponding to the virtual projectile according to the target physical strength value ratio; and determining the throwing distance of the throwing curve according to the gravitational acceleration corresponding to the virtual projectile.

In other words, when the at least one attribute includes the throwing distance, before the throwing curve of the virtual projectile is displayed in the virtual scene, the throwing distance of the throwing curve of the virtual projectile further needs to be determined, and a process of determining the throwing distance includes: determining a remaining physical strength value of the virtual object in response to a trigger operation for the throwing control; determining a target physical strength value ratio between the remaining physical strength value of the virtual object and a target physical strength value of the virtual object; determining a gravitational acceleration corresponding to the virtual projectile according to the target physical strength value ratio; and determining a target distance according to the gravitational acceleration corresponding to the virtual projectile, the throwing distance of the throwing curve displayed in the virtual scene being the target distance.

When the at least one attribute includes the throwing distance, the throwing distance of the throwing curve is determined according to the target physical strength value ratio, so that the correlation between the throwing distance of the throwing curve and the target physical strength value ratio can be improved, thereby improving the display effect of the throwing curve in terms of throwing distance, further improving the interaction experience of the target object, and improving the human-computer interaction rate.

The throwing distance is a distance between a landing point of the virtual projectile and the virtual object, for example, a horizontal distance between the landing point of the virtual projectile and the virtual object. As the remaining physical strength value of the virtual object decreases, the throwing distance of the virtual projectile may decrease accordingly. When the remaining physical strength value of the virtual object gradually restores, the throwing distance of the virtual projectile may increase accordingly. For example, the throwing distance is in a positive correlation with the remaining physical strength value of the virtual object. That is, a smaller remaining physical strength value of the virtual object indicates a smaller throwing distance.

For example, a process of determining a throwing distance (that is, the target distance) of the throwing curve according to the gravitational acceleration corresponding to the virtual projectile includes: determining a throwing time according to the gravitational acceleration corresponding to the virtual projectile and a vertical initial speed of the virtual projectile; and determining the throwing distance (that is, the target distance) of the throwing curve according to the throwing time and a horizontal initial speed of the virtual projectile. The horizontal initial speed of the virtual projectile is a component of an initial speed of the virtual projectile in the horizontal direction. The horizontal initial speed of the virtual projectile is configured based on experience, or adjusted according to an implementation environment. This is not limited in this embodiment of this application. For example, the horizontal initial speed of the virtual projectile is 5 m/s.

A process of determining a throwing time according to the gravitational acceleration corresponding to the virtual projectile and a vertical initial speed of the virtual projectile is described above. Details are not described herein again.

The throwing distance is determined according to the throwing time and the horizontal initial speed, where the throwing time is determined according to the vertical initial speed, so that it can be ensured that the throwing distance is a throwing distance matching an actual physical falling situation, thereby improving the reliability of the throwing distance, improving the display effect of the throwing curve, further improving the interaction experience of the target object, and improving the human-computer interaction rate.

For example, a manner of determining the throwing distance (that is, the target distance) of the throwing curve according to the throwing time and the horizontal initial speed of the virtual projectile is: multiplying the throwing time and the horizontal initial speed of the virtual projectile, to obtain a second product; and determining the throwing distance (that is, the target distance) of the throwing curve based on the second product. For example, the target distance is determined based on the following Formula (3) according to the throwing time and the horizontal initial speed of the virtual projectile.

$$s = {v}_{2} t \qquad Formula ( 3 )$$

In the foregoing Formula (3), s is a target distance, v₂ is a horizontal initial speed of the virtual projectile, and t is a throwing time.

In a possible implementation, the at least one attribute of the throwing curve is determined according to the target physical strength value ratio when the target physical strength value ratio is less than a ratio threshold. That is, the foregoing operation of determining at least one attribute of the throwing curve according to the target physical strength value ratio is performed when the target physical strength value ratio is less than a ratio threshold. The ratio threshold is set based on experience, or adjusted according to an implementation environment. This is not limited in this embodiment of this application. For example, the ratio threshold is 0.5.

Only when the target physical strength value ratio is relatively low, the at least one attribute of the throwing curve is determined according to the target physical strength value ratio, so that the amount of calculation required for determining the at least one attribute of the throwing curve according to the target physical strength value ratio can be reduced, the efficiency of determining the at least one attribute of the throwing curve according to the target physical strength value ratio is improved, and the efficiency of displaying the throwing curve is further improved.

For example, when the at least one attribute includes a transparency and the target physical strength value ratio is less than the ratio threshold, the transparency of the first curve segment of the throwing curve is determined according to the target physical strength value ratio.

For example, when the at least one attribute includes a throwing deflection angle and the target physical strength value ratio is lower than the ratio threshold, the throwing deflection angle of the throwing curve is determined according to the target physical strength value ratio.

For example, when the at least one attribute includes a throwing height and the target physical strength value ratio is less than the ratio threshold, the gravitational acceleration corresponding to the virtual projectile is determined according to the target physical strength value ratio; and the throwing height of the throwing curve is determined according to the gravitational acceleration corresponding to the virtual projectile.

For example, when the at least one attribute includes a throwing distance and the target physical strength value ratio is less than the ratio threshold, the gravitational acceleration corresponding to the virtual projectile is determined according to the target physical strength value ratio and the throwing distance of the throwing curve is determined according to the gravitational acceleration corresponding to the virtual projectile.

In another possible implementation, the at least one default attribute is used as the at least one attribute of the throwing curve when the target physical strength value ratio is not less than the ratio threshold. The at least one default attribute may be set based on experience, or may be adjusted according to an implementation environment. This is not limited in this embodiment of this application.

In a possible implementation, after the throwing curve of the virtual projectile is displayed in the virtual scene, in response to that the trigger operation ends, the virtual projectile is thrown according to the throwing curve. After the virtual projectile is thrown according to the throwing curve, the target object can see, in the display interface, that the virtual projectile moves along the throwing curve. The throwing curve is associated with the remaining physical strength value of the virtual object, and therefore the reliability of the throwing curve is relatively high, so that the visual effect brought by the virtual projectile moving along the throwing curve is improved, the interaction experience of the target object is improved, and further the human-computer interaction rate is improved.

For example, the at least one attribute includes a throwing height, a throwing distance, and a throwing deflection angle. When a virtual projectile is thrown, a throwing height of the virtual projectile is the target height, a throwing distance between a landing point of the virtual projectile and the virtual object is the target distance, and a throwing deflection angle of the virtual projectile is the target angle. The target height, the target distance, and the target angle are all determined based on the remaining physical strength value of the virtual object, and are all described in the foregoing process. Details are not described herein again.

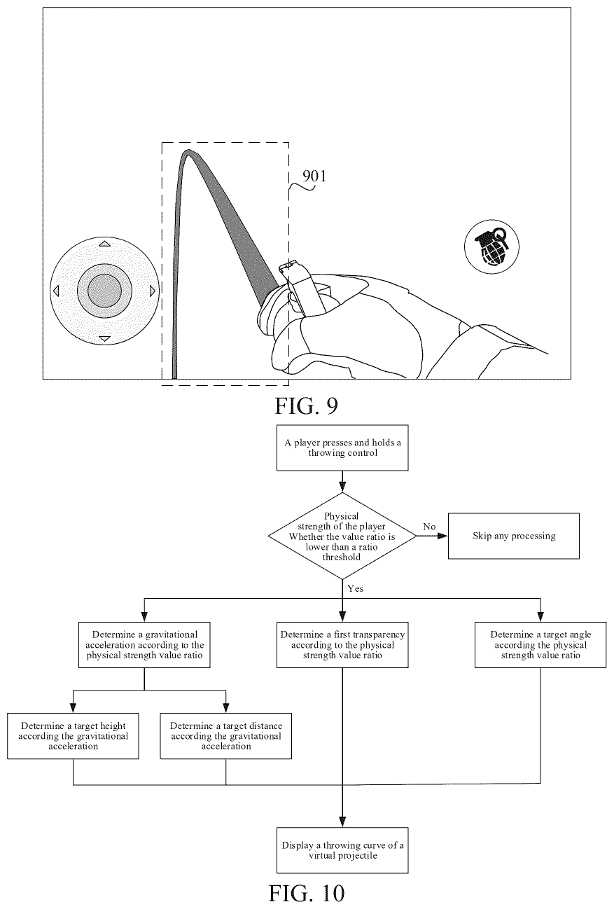

In some embodiments, the throwing curve of the virtual projectile is displayed in the virtual scene based on the physical strength value ratio between the remaining physical strength value of the virtual object and the target physical strength value of the virtual object being not less than the ratio threshold. The transparency of the throwing curve is the second transparency. FIG. 9 is a schematic display diagram of a throwing curve of another virtual projectile according to an embodiment of this application. 901 in FIG. 9 is the throwing curve of the virtual projectile.

In the method, when a virtual projectile is thrown, an attribute of a throwing curve of the virtual projectile is determined according to a remaining physical strength value of a virtual object, and then the virtual projectile is displayed according to the attribute of the throwing curve of the virtual projectile. When remaining physical strength values of virtual objects are different, the attributes of the throwing curves of the virtual projectiles are different. The attribute of the throwing curve of the virtual projectile is associated with the remaining physical strength value of the virtual object, so that the throwing curve of the virtual projectile is more diversified and has a better display effect, thereby facilitating in improvement of the interaction experience of players and increasing the human-computer interaction rate. In addition, the display manner of the throwing curve enables a player to know a situation in which the virtual projectile is thrown under the current remaining physical strength value, so that the player can appropriately control, according to the current remaining physical strength value, a frequency of throwing the virtual projectile, thereby enabling the utilization of the virtual projectile to be more appropriate.

FIG. 10 is a flowchart of a game interaction method according to an embodiment of this application. The method includes:

pressing and holding, by a player, a throwing control; and determining, in response to a press-and-hold operation by the player on the throwing control, whether a physical strength value ratio of the player is lower than a ratio threshold; if the physical strength value ratio of the player is not less than the ratio threshold, skipping any processing; if the physical strength value ratio of the player is less than the ratio threshold, determining a first transparency according to the physical strength value ratio of the player; determining a target angle according to the physical strength value ratio of the player; determining a gravitational acceleration according to the physical strength value ratio of the player; determining a target height and a target distance according to the gravitational acceleration; displaying a throwing curve of the virtual projectile according to the first transparency, the target angle, the target height, and the target distance, a transparency of a first curve segment of the throwing curve being the first transparency, a transparency of a second curve segment being the second transparency, the second transparency being lower than the first transparency, a throwing height of the throwing curve being the target height, a throwing distance of the throwing curve being the target distance, and a throwing deflection angle of the throwing curve being the target angle; a ratio of a distance between any point included in the first curve segment and the virtual object to a length of the throwing curve being greater than a distance ratio, and the second curve segment being a curve segment other than the first curve segment in the throwing curve. The physical strength value ratio of the player in this embodiment is the target physical strength value ratio in the foregoing embodiment.

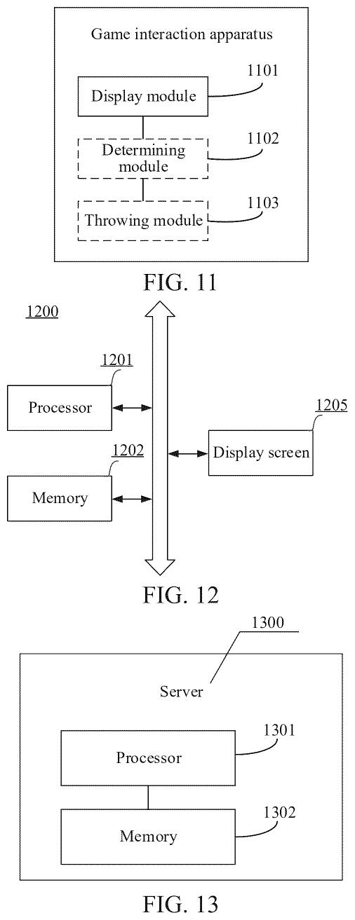

FIG. 11 is a schematic structural diagram of a game interaction apparatus according to an embodiment of this application. As shown in FIG. 11, the apparatus includes:
a display module 1101, configured to display a virtual scene, a virtual object and a throwing control being displayed in the virtual scene, the virtual object holding a virtual projectile, and the throwing control being configured for throwing the virtual projectile; and
the display module 1101, further configured to display, in response to a trigger operation for the throwing control, a throwing curve of the virtual projectile in the virtual scene, at least one attribute of the throwing curve being determined based on a remaining physical strength value of the virtual object, and the at least one attribute including at least one of a transparency, a throwing deflection angle, a throwing height, or a throwing distance.

In a possible implementation, the apparatus further includes:
a determining module 1102, configured to: determine a remaining physical strength value of the virtual object in response to a trigger operation for the throwing control; determine a target physical strength value ratio, the target physical strength value ratio being a ratio of the remaining physical strength value of the virtual object to an original physical strength value of the virtual object; and determine the at least one attribute of the throwing curve according to the target physical strength value ratio.

In a possible implementation, the at least one attribute includes a transparency.

The determining module 1102 is configured to determine a transparency of a first curve segment of the throwing curve according to the target physical strength value ratio, where the transparency of the first curve segment is different from a transparency of a second curve segment, a ratio of a distance between any point included in the first curve segment and the virtual object to a length of the throwing curve is greater than a distance ratio, and the second curve segment is a curve segment other than the first curve segment in the throwing curve.

In a possible implementation, the determining module 1102 is configured to obtain a correspondence between the transparency and the physical strength value ratio; and determine the transparency of the first curve segment of the throwing curve according to the target physical strength value ratio and the correspondence between the transparency and the physical strength value ratio.

In a possible implementation, the determining module 1102 is configured to obtain a first physical strength value ratio, a transparency corresponding to the first physical strength value ratio, a second physical strength value ratio, and a transparency corresponding to the second physical strength value ratio; construct a first reference function, the first reference function being a unary once function; and adjust the first reference function according to the first physical strength value ratio, the transparency corresponding to the first physical strength value ratio, the second physical strength value ratio, and the transparency corresponding to the second physical strength value ratio, to obtain a first function, the first function being configured for indicating the correspondence between the transparency and the physical strength value ratio.

In a possible implementation, the at least one attribute includes the throwing deflection angle.

The determining module 1102 is configured to determine a throwing deflection angle of the throwing curve according to the target physical strength value ratio, the throwing deflection angle being configured for indicating a deflection angle of a throwing direction when the virtual object throws the virtual projectile at the target physical strength value ratio.

In a possible implementation, the determining module 1102 is configured to obtain a correspondence between the deflection angle and the physical strength value ratio; and determine the throwing deflection angle of the throwing curve according to the target physical strength value ratio and the correspondence between the deflection angle and the physical strength value ratio.

In a possible implementation, the at least one attribute includes the throwing height.

The determining module 1102 is configured to determine a gravitational acceleration corresponding to the virtual projectile according to the target physical strength value ratio; and determine the throwing height of the throwing curve according to the gravitational acceleration corresponding to the virtual projectile.

In a possible implementation, the determining module 1102 is configured to obtain a correspondence between a rate of a standard gravitational acceleration and a physical strength value ratio; determine a rate of the standard gravitational acceleration corresponding to the target physical strength value ratio according to the target physical strength value ratio and the correspondence between the rate of the standard gravitational acceleration and the physical strength value ratio; and determine a gravitational acceleration corresponding to the virtual projectile according to the rate of the standard gravitational acceleration corresponding to the target physical strength value ratio and the standard gravitational acceleration.

In a possible implementation, the determining module 1102 is configured to determine a throwing time according to the gravitational acceleration corresponding to the virtual projectile and the vertical initial speed of the virtual projectile; and determine a throwing height of the throwing curve according to the gravitational acceleration corresponding to the virtual projectile and the throwing time.

In a possible implementation, the at least one attribute further includes a throwing distance.

The determining module 1102 is configured to determine a gravitational acceleration corresponding to the virtual projectile according to the target physical strength value ratio; and determine the throwing distance of the throwing curve according to the gravitational acceleration corresponding to the virtual projectile.

In a possible implementation, the determining module 1102 is configured to determine a throwing time according to a gravitational acceleration corresponding to the virtual projectile and the vertical initial speed of the virtual projectile; and determine a throwing distance of the throwing curve according to the throwing time and a horizontal initial speed of the virtual projectile.

In a possible implementation, the remaining physical strength value of the virtual object includes a remaining upper limb physical strength value of the virtual object, and the original physical strength value of the virtual object includes a maximum upper limb physical strength value of the virtual object.

In a possible implementation, an upper limb physical strength bar of the virtual object may be further displayed in the virtual scene, the upper limb physical strength bar of the virtual object is configured for indicating the remaining upper limb physical strength value of the virtual object and the maximum upper limb physical strength value of the virtual object, and the remaining upper limb physical strength value of the virtual object and the maximum upper limb physical strength value of the virtual object are displayed in the upper limb physical strength bar of the virtual object in different manners.

In a possible implementation, the determining module 1102 is configured to determine the at least one attribute of the throwing curve according to the target physical strength value ratio when the target physical strength value ratio is less than a ratio threshold. In a possible implementation, the apparatus further includes:

a throwing module 1103, configured to throw, in response to that the trigger operation ends, the virtual projectile according to the throwing curve.

In the apparatus, when a virtual projectile is thrown, an attribute of a throwing curve of the virtual projectile is determined according to a remaining physical strength value of a virtual object, and then the virtual projectile is displayed according to the attribute of the throwing curve of the virtual projectile. When remaining physical strength values of virtual objects are different, the attributes of the throwing curves of the virtual projectiles are different. The attribute of the throwing curve of the virtual projectile is associated with the remaining physical strength value of the virtual object, so that the throwing curve of the virtual projectile is more diversified and has a better display effect, thereby facilitating in improvement of the interaction experience of players and increasing the human-computer interaction rate. In addition, the display manner of the throwing curve enables a player to know a situation in which the virtual projectile is thrown under the current remaining physical strength value, so that the player can appropriately control, according to the current remaining physical strength value, a frequency of throwing the virtual projectile, thereby enabling the utilization of the virtual projectile to be more appropriate.

When the apparatus provided above implements the functions of the apparatus, only division into the foregoing function modules is used as an example for description. In the practical application, the functions may be allocated to and completed by different function modules according to requirements. That is, an internal structure of the device is divided into different function modules, to complete all or some of the functions described above. In addition, the apparatus and method embodiments provided in the foregoing embodiments belong to the same conception. For the specific implementation process, refer to the method embodiments. Details are not described herein again.

FIG. 12 is a structural block diagram of a terminal device 1200 according to an exemplary embodiment of this application. The terminal device 1200 may be any electronic device product that may perform human-computer interaction with a user in one or more manners such as a keyboard, a touchpad, a remote control, voice interaction, or a handwriting device, for example, a personal computer (PC), a mobile phone, a smartphone, a personal digital assistant (PDA), a wearable device, a pocket PC (PPC), a tablet computer, a smart on board unit, a smart television, or a smart speaker.

Generally, the terminal device 1200 includes: a processor 1201 and a memory 1202.

The processor 1201 may include one or more processing cores, for example, a 4-core processor or an 8-core processor. The processor 1201 may be implemented in at least one hardware form of a digital signal processor (DSP), a field-programmable gate array (FPGA), and a programmable logic array (PLA). The processor 1201 may further include a main processor and a coprocessor. The main processor is a processor configured to process data in an awake state, and is also referred to as a central processing unit (CPU). The coprocessor is a low power consumption processor configured to process the data in a standby state. In some embodiments, the processor 1201 may be integrated with a graphics processing unit (GPU). The GPU is configured to render and draw content that needs to be displayed on a display screen. In some embodiments, the processor 1201 may further include an artificial intelligence (AI) processor. The AI processor is configured to process computing operations related to machine learning.

The memory 1202 may include one or more computer-readable storage media. The computer-readable storage medium may be non-transient. The memory 1202 may further include a high-speed random access memory and a nonvolatile memory, for example, one or more disk storage devices or flash storage devices. In some embodiments, the non-transient computer-readable storage medium in the memory 1202 is configured to store at least one instruction, and the at least one instruction is configured for being executed by the processor 1201 to implement the game interaction method provided in the method embodiments of this application.

In some embodiments, the terminal device 1200 may further include: a display screen 1205.

The display screen 1205 is configured to display a user interface (UI). The UI may include a graph, text, an icon, a video, and any combination thereof. When the display screen 1205 is a touch display screen, the display screen 1205 further has a capability of acquiring a touch signal on or above a surface of the display screen 1205. The touch signal may be inputted to the processor 1201 as a control signal for processing. In this case, the display screen 1205 may be further configured to provide a virtual button and/or a virtual keyboard, also referred to as a soft button and/or a soft keyboard. In some embodiments, there may be one display screen 1205, disposed on a front panel of the terminal device 1200. In some other embodiments, there may be at least two display screens 1205, respectively disposed on different surfaces of the terminal device 1200 or designed in a foldable shape. In still some other embodiments, the display screen 1205 may be a flexible display screen, disposed on a curved surface or a folded surface of the terminal device 1200. Even, the display screen 1205 may alternatively be disposed in a non-rectangular irregular pattern, namely, a special-shaped screen. The display screen 1205 may be made of a liquid crystal display (LCD), an organic light-emitting diode (OLED), or other materials.

A person skilled in the art may understand that the structure shown in FIG. 12 constitutes no limitation on the terminal device 1200, and the terminal may include more or fewer components than those shown in the figure, or some components may be combined, or a different component deployment may be used.

FIG. 13 is a schematic structural diagram of a server according to an embodiment of this application. The server 1300 may vary a lot due to different configurations or performance, and may include one or more CPUs 1301 and one or more memories 1302. The one or more memories 1302 store at least one instruction, and the at least one instruction is loaded and executed by the one or more CPUs 1301 to implement the game interaction method provided in the foregoing method embodiments. The server 1300 may further have assemblies such as a wired or wireless network interface, a keyboard, and an I/O interface for inputting and outputting. The server 1300 may further include other assemblies configured to implement device functions, and details are not described herein.

In an exemplary embodiment, a non-transitory computer-readable storage medium is further provided, the storage medium having at least one program code stored therein, and the at least one program code being loaded and executed by a processor, to cause a computer to implement any one of the foregoing game interaction methods.

In some embodiments, the computer-readable storage medium may be a read-only memory (ROM), a random access memory (RAM), a compact disc read-only memory (CD-ROM), a magnetic tape, a floppy disk, an optical data storage device, or the like.

In an exemplary embodiment, a computer program or a computer program product is further provided, the computer program or the computer program product stores at least one computer instruction, and the at least one computer instruction is loaded and executed by a processor, to cause a computer to implement any one of the foregoing game interaction methods.

Information (including but not limited to user equipment information, user personal information, and the like), data (including but not limited to data for analysis, data for storage, data for display, and the like), and signals involved in this application are all authorized by users or fully authorized by all parties, and collection, use, and processing of relevant data need to comply with relevant laws, regulations, and standards of relevant regions. For example, the virtual scenes and some information involved in this application are obtained with a full authority.

“Plurality of” mentioned in the specification means two or more. “And/or” describes an association relationship for describing associated objects and represents that three relationships may exist. For example, A and/or B may represent the following three cases: Only A exists, both A and B exist, and only B exists. The character “/” in this specification generally indicates an “or” relationship between the associated objects.

The foregoing descriptions are merely exemplary embodiments of this application, but are not intended to limit this application. Any modification, equivalent replacement, or improvement made within the principle of this application shall fall within the protection scope of this application.

What is claimed is:

1. A game interaction method performed by a computer device, and the method comprising:
displaying a virtual scene including a virtual object holding a virtual projectile and a throwing control, and the throwing control being configured for throwing the virtual projectile;
in response to a trigger operation for the throwing control, generating a throwing curve of the virtual projectile in the virtual scene, at least one attribute of the throwing curve being determined based on a remaining physical strength value of the virtual object, and the at least one attribute comprising at least one of a transparency, a throwing deflection angle, a throwing height, or a throwing distance; and
in response to that the trigger operation ends, throwing the virtual projectile according to the throwing curve.

2. The method according to claim 1, wherein the method further comprises:
determining, in response to the trigger operation for the throwing control, a remaining physical strength value of the virtual object;
determining a target physical strength value ratio, the target physical strength value ratio being a ratio of the remaining physical strength value of the virtual object to an original physical strength value of the virtual object; and
determining at least one attribute of the throwing curve according to the target physical strength value ratio.

3. The method according to claim 2, wherein the at least one attribute comprises the transparency; and the determining at least one attribute of the throwing curve according to the target physical strength value ratio comprises:
determining a transparency of a first curve segment of the throwing curve according to the target physical strength value ratio,
wherein the transparency of the first curve segment is different from a transparency of a second curve segment, a ratio of a distance between any point comprised in the first curve segment and the virtual object to a length of the throwing curve is greater than a distance ratio, and the second curve segment is a curve segment other than the first curve segment in the throwing curve.

4. The method according to claim 2, wherein the at least one attribute comprises the throwing deflection angle; and the determining at least one attribute of the throwing curve according to the target physical strength value ratio comprises:
determining a throwing deflection angle of the throwing curve according to the target physical strength value ratio, the throwing deflection angle being configured for indicating a deflection angle of a throwing direction when the virtual object throws the virtual projectile at the target physical strength value ratio.

5. The method according to claim 2, wherein the at least one attribute comprises a throwing height; and the determining at least one attribute of the throwing curve according to the target physical strength value ratio comprises:
determining a gravitational acceleration corresponding to the virtual projectile according to the target physical strength value ratio; and
determining the throwing height of the throwing curve according to the gravitational acceleration corresponding to the virtual projectile.

6. The method according to claim 2, wherein the at least one attribute comprises a throwing distance; and the determining at least one attribute of the throwing curve according to the target physical strength value ratio comprises:
determining a gravitational acceleration corresponding to the virtual projectile according to the target physical strength value ratio; and
determining the throwing distance of the throwing curve according to the gravitational acceleration corresponding to the virtual projectile.

7. The method according to claim 2, wherein the remaining physical strength value of the virtual object comprises a remaining upper limb physical strength value of the virtual object, and the original physical strength value of the virtual object comprises a maximum upper limb physical strength value of the virtual object.

8. The method according to claim 2, wherein the determining at least one attribute of the throwing curve according to the target physical strength value ratio comprises:
determining the at least one attribute of the throwing curve according to the target physical strength value ratio when the target physical strength value ratio is less than a ratio threshold.

9. A computer device, the computer device comprising a processor and a memory, the memory having at least one program code stored therein, and the at least one program code, when being loaded and executed by the processor, causing the computer device to implement a game interaction method including:
displaying a virtual scene including a virtual object holding a virtual projectile and a throwing control, and the throwing control being configured for throwing the virtual projectile;
in response to a trigger operation for the throwing control, generating a throwing curve of the virtual projectile in the virtual scene, at least one attribute of the throwing curve being determined based on a remaining physical strength value of the virtual object, and the at least one attribute comprising at least one of a transparency, a throwing deflection angle, a throwing height, or a throwing distance; and
in response to that the trigger operation ends, throwing the virtual projectile according to the throwing curve.

10. The computer device according to claim 9, wherein the method further comprises:
determining, in response to the trigger operation for the throwing control, a remaining physical strength value of the virtual object;
determining a target physical strength value ratio, the target physical strength value ratio being a ratio of the remaining physical strength value of the virtual object to an original physical strength value of the virtual object; and
determining at least one attribute of the throwing curve according to the target physical strength value ratio.

11. The computer device according to claim 10, wherein the at least one attribute comprises the transparency; and the determining at least one attribute of the throwing curve according to the target physical strength value ratio comprises:
determining a transparency of a first curve segment of the throwing curve according to the target physical strength value ratio,
wherein the transparency of the first curve segment is different from a transparency of a second curve segment, a ratio of a distance between any point comprised in the first curve segment and the virtual object to a length of the throwing curve is greater than a distance ratio, and the second curve segment is a curve segment other than the first curve segment in the throwing curve.

12. The computer device according to claim 10, wherein the at least one attribute comprises the throwing deflection angle; and the determining at least one attribute of the throwing curve according to the target physical strength value ratio comprises:
determining a throwing deflection angle of the throwing curve according to the target physical strength value ratio, the throwing deflection angle being configured for indicating a deflection angle of a throwing direction when the virtual object throws the virtual projectile at the target physical strength value ratio.

13. The computer device according to claim 10, wherein the at least one attribute comprises a throwing height; and the determining at least one attribute of the throwing curve according to the target physical strength value ratio comprises:
determining a gravitational acceleration corresponding to the virtual projectile according to the target physical strength value ratio; and
determining the throwing height of the throwing curve according to the gravitational acceleration corresponding to the virtual projectile.

14. The computer device according to claim 10, wherein the at least one attribute comprises a throwing distance; and the determining at least one attribute of the throwing curve according to the target physical strength value ratio comprises:
determining a gravitational acceleration corresponding to the virtual projectile according to the target physical strength value ratio; and
determining the throwing distance of the throwing curve according to the gravitational acceleration corresponding to the virtual projectile.

15. The computer device according to claim 10, wherein the remaining physical strength value of the virtual object comprises a remaining upper limb physical strength value of the virtual object, and the original physical strength value of the virtual object comprises a maximum upper limb physical strength value of the virtual object.

16. The computer device according to claim 10, wherein the determining at least one attribute of the throwing curve according to the target physical strength value ratio comprises:
determining the at least one attribute of the throwing curve according to the target physical strength value ratio when the target physical strength value ratio is less than a ratio threshold.

17. A non-transitory computer-readable storage medium, having at least one program code stored therein, and the at least one program code, when being loaded and executed by a processor of a computer device, causing the computer device to implement a game interaction method including:
displaying a virtual scene including a virtual object holding a virtual projectile and a throwing control, and the throwing control being configured for throwing the virtual projectile;
in response to a trigger operation for the throwing control, generating a throwing curve of the virtual projectile in the virtual scene, at least one attribute of the throwing curve being determined based on a remaining physical strength value of the virtual object, and the at least one attribute comprising at least one of a transparency, a throwing deflection angle, a throwing height, or a throwing distance; and
in response to that the trigger operation ends, throwing the virtual projectile according to the throwing curve.

18. The non-transitory computer-readable storage medium according to claim 17, wherein the method further comprises:
determining, in response to the trigger operation for the throwing control, a remaining physical strength value of the virtual object;
determining a target physical strength value ratio, the target physical strength value ratio being a ratio of the remaining physical strength value of the virtual object to an original physical strength value of the virtual object; and
determining at least one attribute of the throwing curve according to the target physical strength value ratio.

19. The non-transitory computer-readable storage medium according to claim 18, wherein the at least one attribute comprises the transparency; and the determining at least one attribute of the throwing curve according to the target physical strength value ratio comprises:
determining a transparency of a first curve segment of the throwing curve according to the target physical strength value ratio,
wherein the transparency of the first curve segment is different from a transparency of a second curve segment, a ratio of a distance between any point comprised in the first curve segment and the virtual object to a length of the throwing curve is greater than a distance ratio, and the second curve segment is a curve segment other than the first curve segment in the throwing curve.

20. The non-transitory computer-readable storage medium according to claim 18, wherein the at least one attribute comprises the throwing deflection angle; and the determining at least one attribute of the throwing curve according to the target physical strength value ratio comprises:
determining a throwing deflection angle of the throwing curve according to the target physical strength value ratio, the throwing deflection angle being configured for indicating a deflection angle of a throwing direction when the virtual object throws the virtual projectile at the target physical strength value ratio.
